(19) United States
(12) Patent Application Publication
(10) Pub. No.: US 2013/0227572 A1
(43) Pub. Date: Aug. 29, 2013

(54) TEST DEVICE, A SYSTEM, A PROGRAM AND A METHOD

(71) Applicant: Shigeru Hosono, Tokyo (JP)

(72) Inventor: Shigeru Hosono, Tokyo (JP)

(73) Assignee: NEC CORPORATION, Tokyo (JP)

(21) Appl. No.: 13/881,253

(22) PCT Filed: Jul. 31, 2012
(86) PCT No.: PCT/JP2012/069932

§ 371 Date: Apr. 24, 2013

(30) Foreign Application Priority Data
Aug. 1, 2011 (JP) 2011-168011

(51) Int. Cl. G06F 9/455; H04L 29/08

(52) U.S. Cl. CPC G06F 9/455; H04L 29/08846
USPC 718/1; 709/223

(57) ABSTRACT

A test device includes: an identifier storage means for storing: an identifier of a server information storage means for storing a server specification for each of a plurality of servers; an identifier of an application information storage means for storing application information including a module name for each of a plurality of applications; and an identifier of a deployment information storage means for storing deployment information which makes correspond each of the plurality of applications and either of the plurality of servers; and a deployment means for, by referring to the identifier storage means, acquiring the server specification and the module name which correspond for each of the plurality of applications indicated by the deployment information; and deploying a module of the application which the module name concerned indicates on a virtual server on its own device which reflected the server specification concerned.

### TECHNICAL FIELD

A test device, a system, a program and a method

### TECHNICAL FIELD

The present invention relates to a test device, a system, a program and a method.

### BACKGROUND ART

In case function verification of an application is performed, it is necessary to build an operating environment of the application appropriately. For example, in Japanese Unexamined Patent Application Publication No. 2011-60053, an example of a sizing system which, when an application system is built, estimates hardware requirements is disclosed. Also, in Japanese Unexamined Patent Application Publication No. 2010-49688, an example of a technology which, in distributed environment, maps applications to resources is disclosed.

### DISCLOSURE OF THE INVENTION

### Problems to be Solved by the Invention

However, in the technologies mentioned above, since a simulation environment is not built by reflecting information of a server to which applications are actually deployed in such as a cloud environment, during development of an application which operates in such as the cloud environment and in case function verification of the application is performed, there was a problem that it was difficult to build the simulation environment of the application appropriately.

Accordingly, in order to solve the problem mentioned above, the present invention makes it the object to provide a test device, a system, a program and a method which can build the simulation environment of the application appropriately.

### Measures for Solving the Problems

In order to achieve the object, one mode of the present invention is a test device and includes: an identifier storage means for storing: an identifier of a server information storage means for storing a server specification for each of a plurality of servers; an identifier of an application information storage means for storing application information including a module name for each of a plurality of applications; and an identifier of a deployment information storage means for storing deployment information which makes correspond each of the plurality of applications and either of the plurality of servers; and a deployment means for, by referring to the identifier storage means, acquiring the server specification and the module name which correspond for each of the plurality of applications indicated by the deployment information; and deploying a module of the application which the module name concerned indicates on a virtual server on its own device which reflected the server specification concerned.

Also, the present invention provides a test program which makes a computer including an identifier storage means for storing: an identifier of a server information storage means for storing a server specification for each of a plurality of servers; an identifier of an application information storage means for storing application information including a module name for each of a plurality of applications; and an identifier of a deployment information storage means for storing deployment information which makes correspond each of the plurality of applications and either of the plurality of servers; execute a deployment step which, by referring to the identifier storage means, acquires the server specification and the module name which correspond for each of the plurality of applications indicated by the deployment information; and deploys a module of the application which the module name concerned indicates on a virtual server on its own device which reflected the server specification concerned.

Also, the present invention provides a test method comprising; storing an identifier of a server information storage means for storing a server specification for each of a plurality of servers; an identifier of an application information storage means for storing application information including a module name for each of a plurality of applications; and an identifier of a deployment information storage means for storing deployment information which makes correspond each of the plurality of applications and either of the plurality of servers in an identifier storage means; and by referring to the identifier storage means, acquires the server specification and the module name which correspond for each of the plurality of applications indicated by the deployment information; and deploys a module of the application which the module name concerned indicates on a virtual server on its own device which reflected the server specification concerned.

### Effect of the Invention

The present invention provides a test device, a system, a program and a method which can build a simulation environment of an application appropriately.

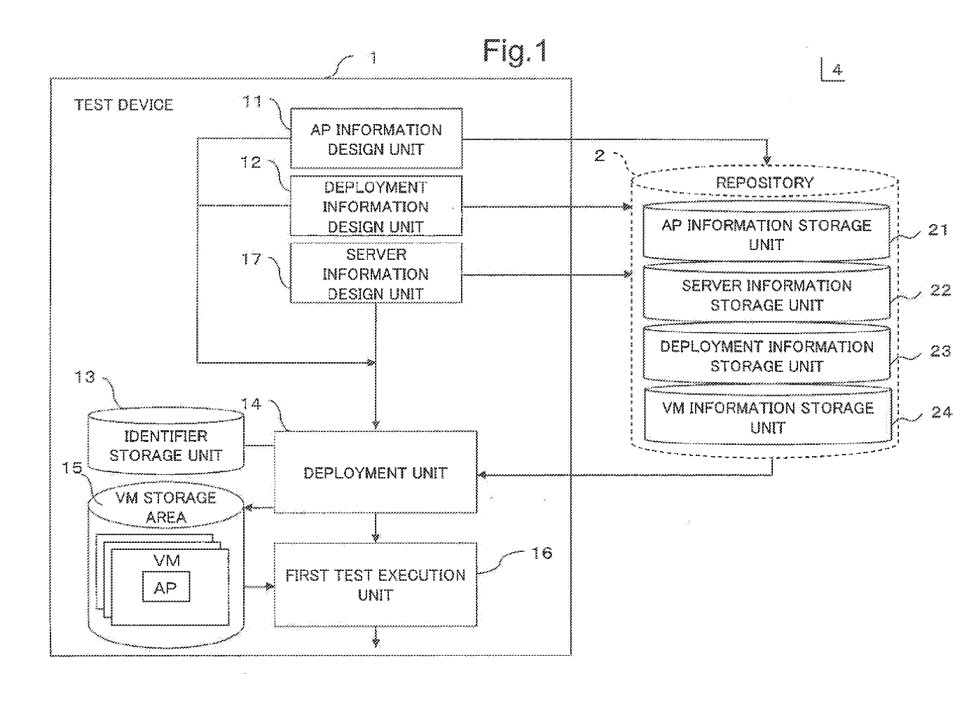

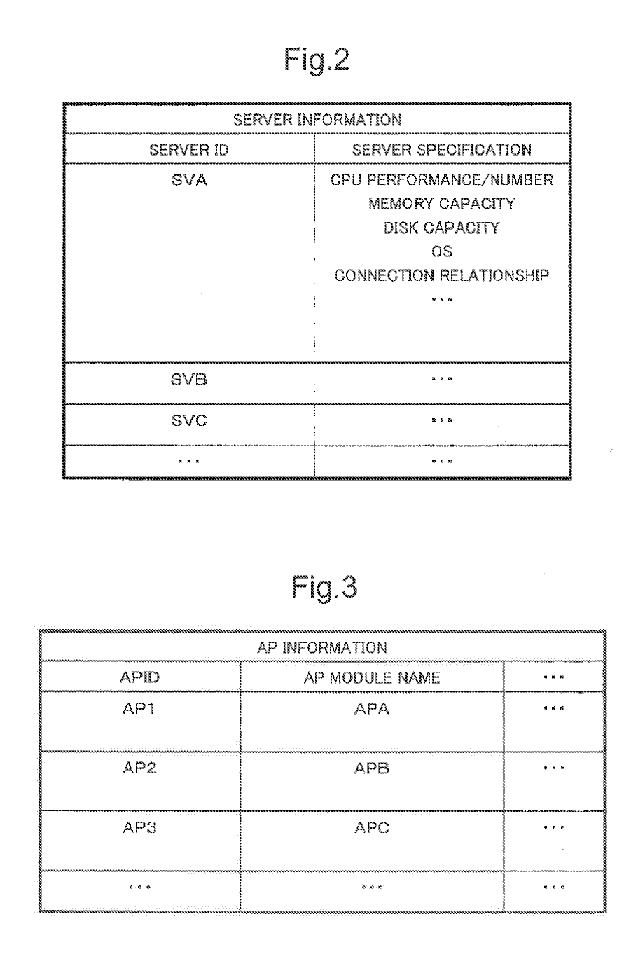

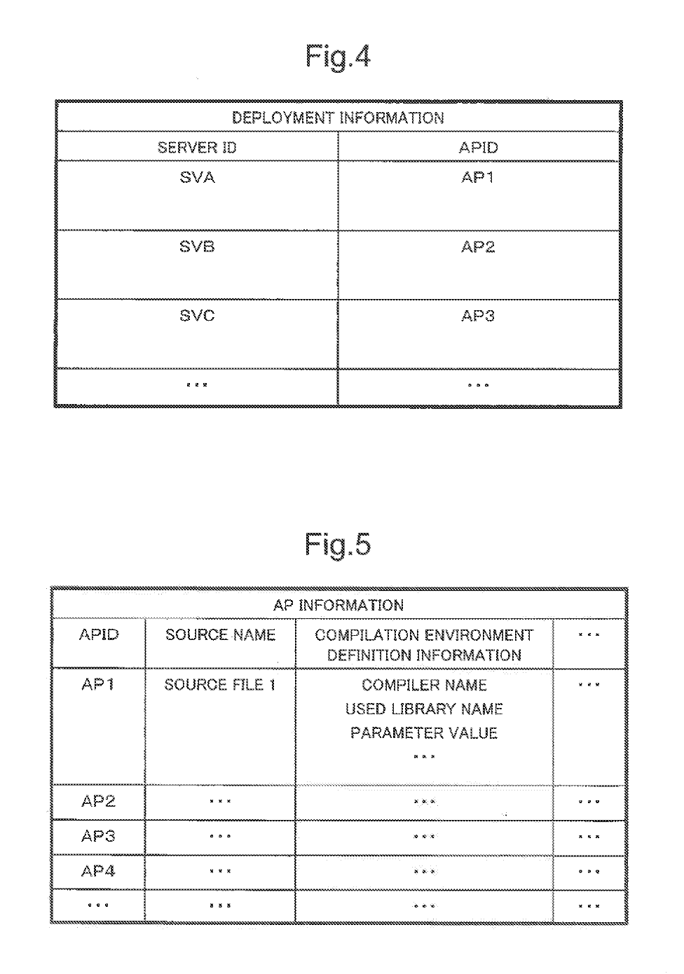

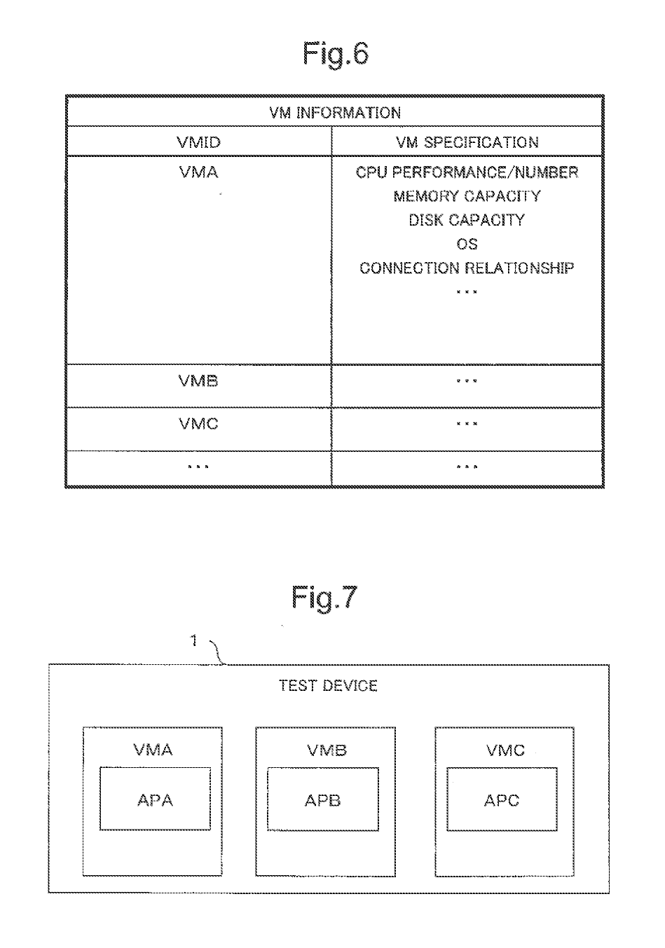

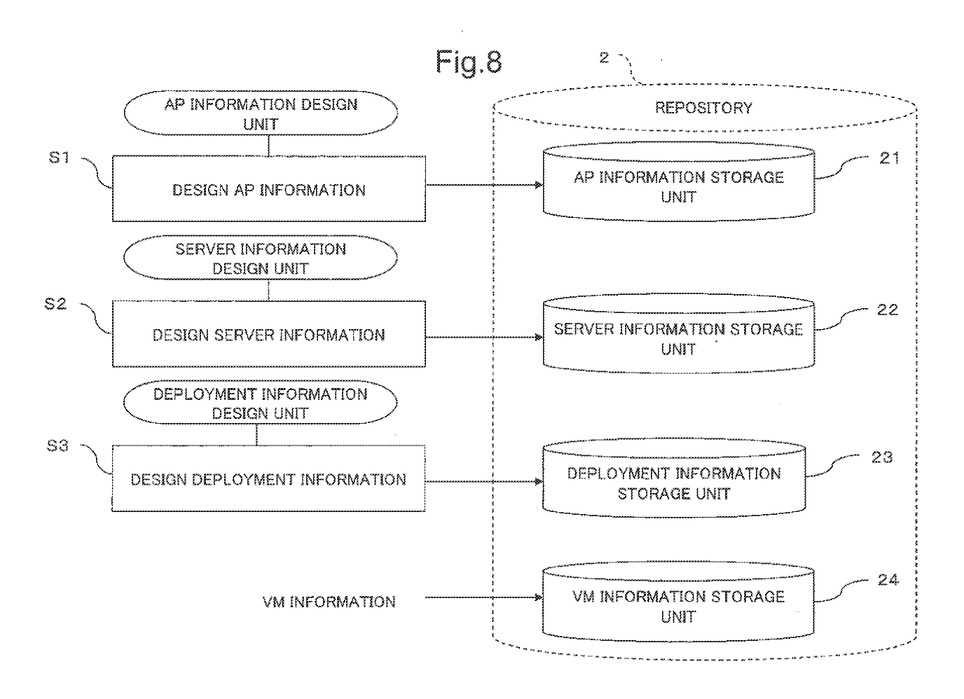

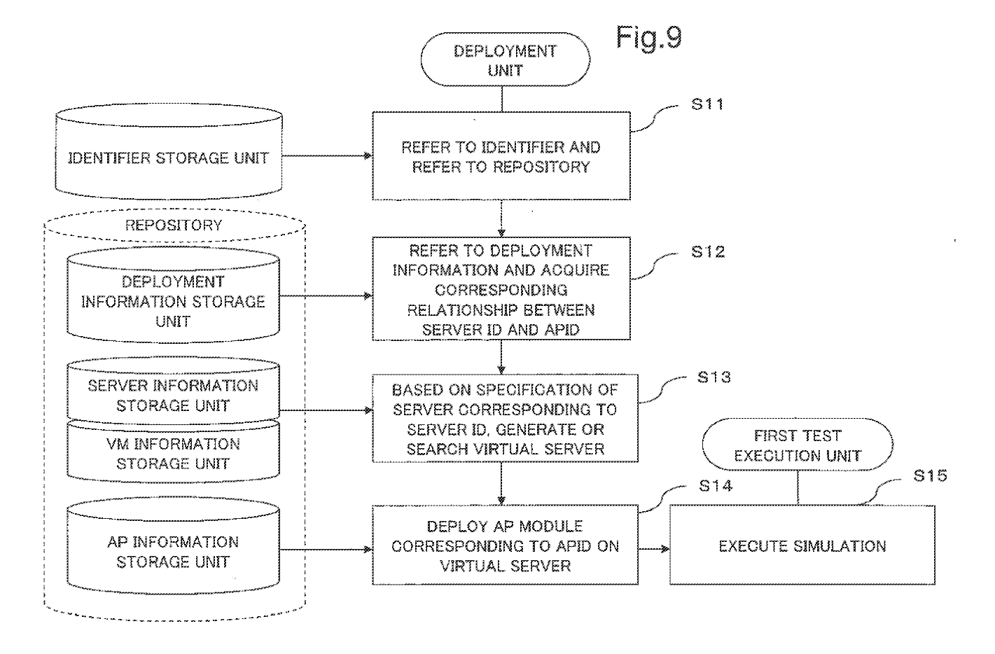

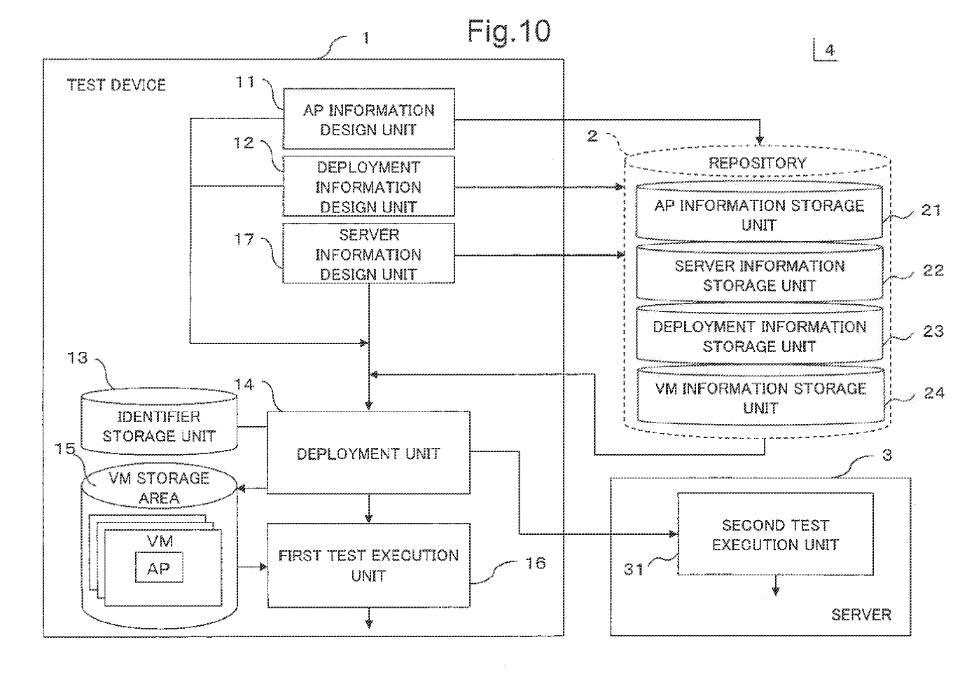

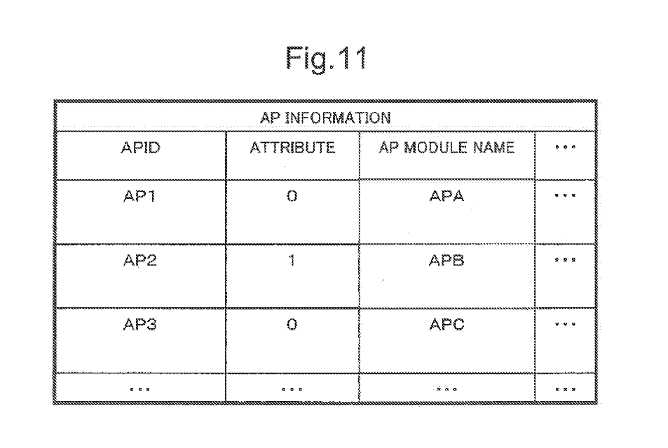

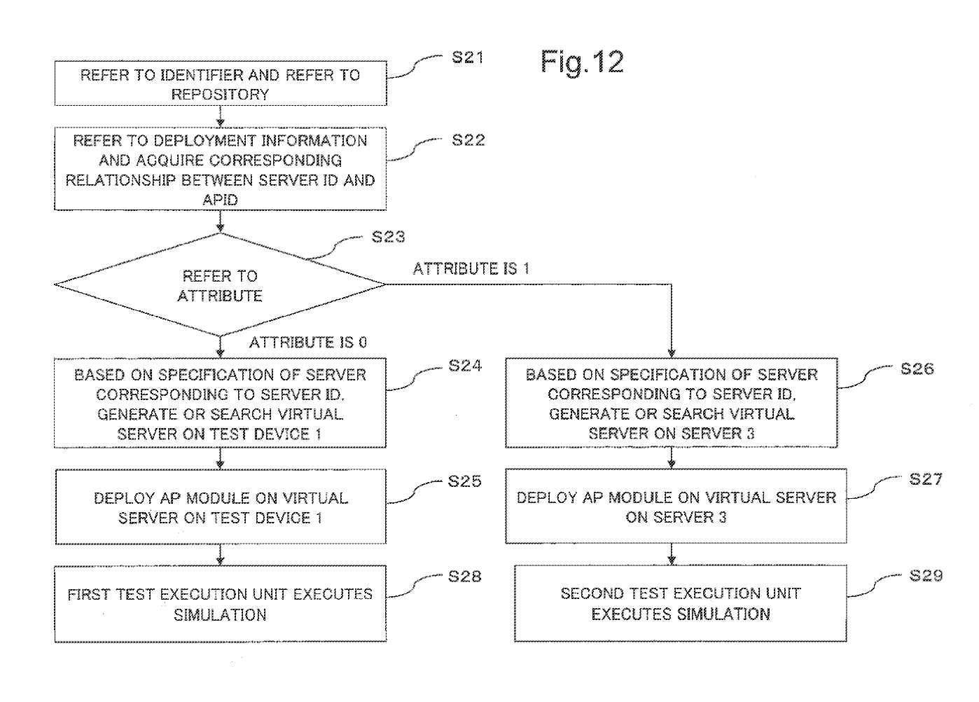

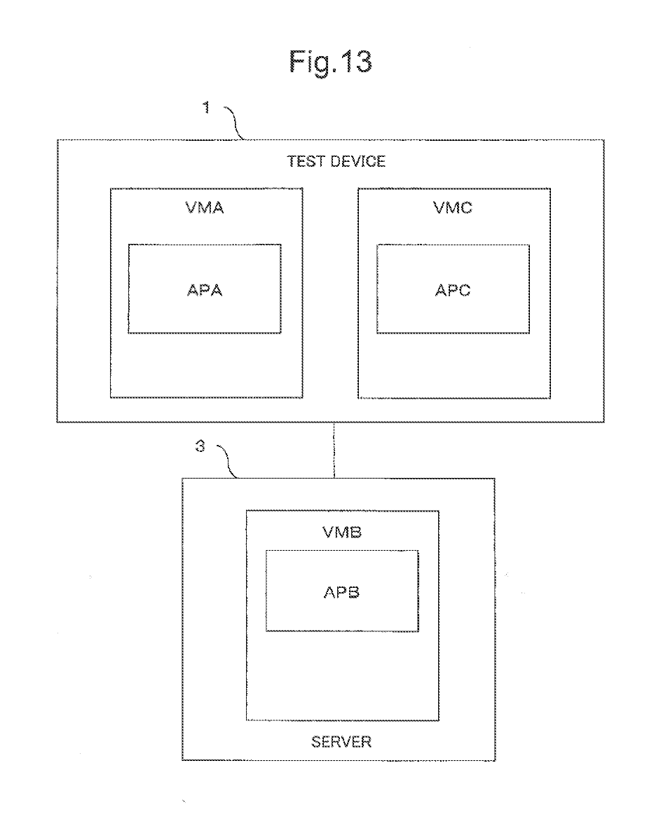

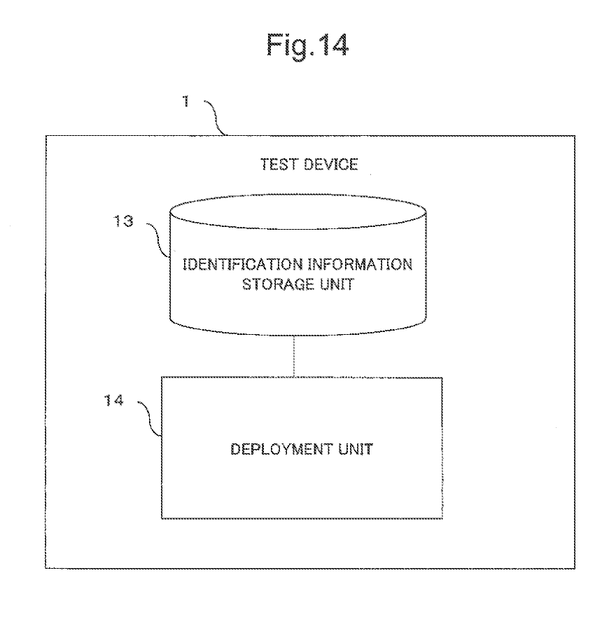

### BRIEF DESCRIPTION OF THE DRAWINGS

[FIG. 1] A figure showing an example of a structure of the first exemplary embodiment.

[FIG. 2] A figure showing an example of server information.

[FIG. 3] A figure showing an example of AP information.

[FIG. 4] A figure showing an example of deployment information.

[FIG. 5] A figure showing an example of AP information.

[FIG. 6] A figure showing an example of VM information.

[FIG. 7] A figure showing an example of a state when AP modules are deployed on virtual servers.

[FIG. 8] A figure describing an example of a repository.

[FIG. 9] A figure showing an example of operation of the first exemplary embodiment.

[FIG. 10] A figure showing an example of a structure of the second exemplary embodiment.

[FIG. 11] A figure showing an example of AP information.

[FIG. 12] A figure showing an example of operation of the second exemplary embodiment.

[FIG. 13] A figure showing an example of a state when AP modules are deployed on virtual servers and a server.

[FIG. 14] A figure showing an example of a structure of the third exemplary embodiment.

### MODES FOR CARRYING OUT THE INVENTION

Hereinafter, exemplary embodiments of the present invention will be described using drawings. In all of the drawings, a same code is attached to a same component, and its description will be omitted appropriately.

Further, each unit which configures a device and so on of each exemplary embodiment is configured by hardware such as a logic circuit. Also, each unit may be comprised of: a control unit of a computer, a memory and a program loaded in the memory, a storage unit such as a hard disk which stores the program and an interface for network connections, and realized by an arbitrary combination of hardware and software. And, if not stated otherwise specifically, its realization method or the device is not limited.

Also, the control unit includes a CPU (Central Processing Unit) and so on, and together with making an OS (Operating system) operate and controlling the whole body such as the device, reads the program and data, for example, from a recording medium loaded on a drive device and so on to the memory and executes various kinds of processing according to this. The recording media are, for example, an optical disc, a flexible disc, a magnetic optical disc, an external hard disk and a semiconductor memory and so on, and record the computer program so that the computer can read. Also, the computer program may be downloaded from an outside computer which is not shown and is connected to a communication network.

### Exemplary Embodiment 1

Next, the first exemplary embodiment of the present invention will be described using drawings.

A test system 4 includes a test device 1 and a repository 2. An example of the test system 4 is shown in FIG. 1. The repository 2 is stored in a disk and so on which is connected to a computer which is not shown. The test device 1 and the computer concerned are connected by a communication line. Further, the repository 2 may be stored in a disk and so on which the test device 1 includes.

First, the repository 2 will be described.

The repository 2 includes an AP information storage unit 21, a server information storage unit 22, a deployment information storage unit 23 and a VM information storage unit 24.

The server information storage unit 22 stores server information. As shown in FIG. 2, the server information is information which indicates a corresponding relationship between a server ID (IDentification) which is an identifier which identifies a server and a specification of the server. The specification (server specification) of the server is various kinds of information about a structure of the server which includes, in addition to hardware configuration such as performance and number of CPU, memory capacity and disk capacity; software specifications such as a structure and a type of an OS, open/close status of a TCP (Transmission Control Protocol) port, a connection relationship and so on. The connection relationship includes: a server identifier of a communication party, a used protocol stack, an other party's address and other communication environment information.

The VM information storage unit 24 stores VM information. As shown in FIG. 6, the VM information is information which indicates a corresponding relationship between a VMID which is an identifier which identifies a virtual server (hereinafter, also referred to as a VM: Virtual Machine) and a specification of the VM. As described later, the VM is generated on the test device 1 in advance or to be generated by a deployment unit 14 on the test device 1. The VM information storage unit 24 receives from the test device 1 information of the VM generated on the test device 1 via a communication line and so on which is not shown and stores it. Here, the specification of the VM (VM specification) is various kinds of information about a structure of the virtual server which includes, in addition to hardware configuration such as performance and number of the CPU, memory capacity and disk capacity of the virtual server; software specifications such as a structure and a type of the OS, open/close status of the TCP port, hierarchy information of a protocol stack, a connection relationship which indicates communication possibility with other virtual servers and so on. The connection relationship includes: the server identifier of the communication party, the used protocol stack, the other party's address and other communication environment information.

The AP information storage unit 21 stores application information (AP information). The deployment information storage unit 23 stores deployment information. Details of the AP information and the deployment information will be described later.

The server information is, for example, information which is set based on a result of a center design performed by a data center administrator and so on. The server information may be information which reflected a structure of a data center which exists in reality, that is, information which the test device 1 received from a computer in the data center.

The deployment information is information which is set based on a result of an application architecture design performed by a service integrator and so on. The AP information is information which is set based on a result of an application program development performed by a program developer.

That is, each of the server information, the AP information and the deployment information is set, for example, by a subject (individual, team or enterprise) with a different standpoint and who participates in an application service system design. Also, the information may be set at different steps or phases in the application service system design by the identical subject. For example, in a cloud computing service, when it is a PaaS (Platform as a Service) style service, an application developer designs the AP information, and a service provider and so on designs the server information and the deployment information.

On the other hand, when it is a SaaS (Software as a Service) style service, the service provider and so on designs the AP information, the server information and the deployment information.

Next, the test device 1 will be described.

The test device 1 includes an AP information design unit 11, a deployment information design unit 12, an identifier storage unit 13, the deployment unit 14, a VM storage area 15 and a first test execution unit 16.

The AP information design unit 11 is a means for designing an application (hereinafter, also referred to as AP: Application) information following an operation of a user who is a program developer and so on, for example, a program development support tool. The application information (AP information) is, for example, information which indicates a corresponding relationship between an APID which is an identifier which identifies an application and an AP module name which indicates a program module (also referred to as a module or an AP module) of the application concerned as shown in FIG. 3, logic configuration information of the application which indicates a calling relationship between the application modules of no smaller than 2 and so on.

The logic configuration information of the application may be described by a language such as an XML (Extensible Markup Language), for example. Also, the AP information may include a source name (source program name) and compilation environment definition information of the application as shown in FIG. 5. Here, the compilation environment definition information is various kinds of information such as a compiler name, a used library name and parameter values which are required to compile a source file which the source name indicates. In case the application is prepared as a source as above, it is possible to make the application and a server of a deployment destination correspond during a design cycle of the application architecture by the deployment information described later. The AP information designed by the AP information design unit 11 is stored in the AP information storage unit 21 in the repository 2. Further, the AP information may be stored in the AP information storage unit 21 in advance. In that case, the test device 1 may not include the AP information design unit 11.

The deployment information design unit 12 is a means for designing deployment information which indicates a relation between an AP module and a server which deploys the AP module concerned following an operation of a user who is a service integrator and so on, for example, an application architecture establishment support tool. An example of the deployment information is shown in FIG. 4. The deployment information makes the server ID which identifies the server and the APID which identifies the application correspond and stores them. The deployment information may be described by a language such as the XML, for example. The deployment information designed by the deployment information design unit 12 is stored in the deployment information storage unit 23 in the repository 2. Further, the deployment information may be stored in the deployment information storage unit 23 in advance. In that case, the test device 1 may not include the deployment information design unit 12.

A server information design unit 17 is a means for designing server information following an operation of a user such as a data center administrator, for example, a center design support tool. The server information is information which indicates a corresponding relationship between the server ID which is the identifier which identifies the server and the specification of the server concerned, for example, as shown in FIG. 2. Further, the server information may be stored in the server information storage unit 22 in advance. In that case, the test device 1 may not include the server information design unit 17.

The identifier storage unit 13 stores: the identifier of the AP information storage unit 21 (the AP information storage unit identifier), the identifier of the server information storage unit 22 (the server information storage unit identifier), an identifier of the deployment information storage unit 23 (the deployment information storage unit identifier) and the identifier of the VM information storage unit 24 (the VM information storage unit identifier). Each of the identifiers is used when the deployment unit 14 which will be described later refers to each storage unit. The identifier storage unit 13 is, for example, a file directory.

The deployment unit 14 refers to the deployment information storage unit 24 of the repository 2 and acquires the deployment information which the deployment information storage unit 24 stores. Also, the deployment unit 14 refers to the server information storage unit 22 of the repository 2 based on the server ID which the deployment information indicates and acquires the server information. Also, the deployment unit 14 generates a virtual server which reflected the server specification which the server information indicates on the test device 1. Here, to generate the virtual server means, for example, the deployment unit 14 stores hardware configuration information of each virtual server in the VM storage area 15, or stores a program such as the OS and the environment setting information which those programs access on the virtual server in a virtual disk (which corresponds to an area in a physical disk) of the virtual server.

Also, the deployment unit 14 acquires the connection relationship from the server information storage unit 22, generates virtual communication path information in correspondence with the virtual server with which communication connection is performed, stores it in the VM storage area 15, generates communication environment definition information and stores it in a configuration information storage area of the OS which is deployed on the virtual server. Further, the administrator and so on may make the connection relationship stored in the server information storage unit 22 as a pattern in advance and store the communication environment definition information which the deployment unit 14 generates in correspondence with the pattern in advance in a memory unit of the test device 1 which is not shown.

Further, in case the virtual server is generated on the test device 1 in advance, the deployment unit 14 may search the virtual server to which the server specification which the server information indicates is reflected. Here, that the server specification is reflected means that the VM specification of the virtual server and the server specification are identical. However, concerning the performance and the storage capacity, since the hardware specification of the virtual server is restricted by the hardware resource of the test device 1 on which the virtual server is generated, there is a case when the deployment unit 14 may not be able to generate the virtual server which reflected the hardware specification completely just as it is on the test device 1.

Also, the deployment unit 14 refers to the AP information storage unit 21 and deploys the module with the AP module name corresponding to the APID of the deployment information on the virtual server which reflected the server specification. Further, in case the APID is made to correspond to the source name and the compilation environment definition information as shown in FIG. 5, based on the compilation environment definition information, the deployment unit 14 deploys the AP module which is a result of compilation of the source file which the source name indicates on the virtual server.

Operation of the deployment unit 14 will be described specifically using FIGS. 1-7. For example, the deployment unit 14 refers to the deployment information of FIG. 4, and grasps that the server ID: SVA and the APID: AP1 correspond. Next, the deployment unit 14 refers to the server information of FIG. 2 and refers to the server specification corresponding to the server ID: SVA. Next, the deployment unit 14 generates a virtual server which reflected the server specification concerned on the test device 1.

The deployment unit 14 sets the VMID of the virtual server which reflected the server specification corresponding to the server ID: SVA as VMA, for example, makes the VMID concerned and the specification of the virtual server concerned correspond, and stores them in the VM information storage unit 24 of FIG. 6 (hereinafter, a virtual server whose VMID is X is also called a virtual server X. For example, a virtual server whose VMID is VMA is also called a virtual server VMA).

Next, the deployment unit 14 refers to the AP information of FIG. 3, and deploys a module with the AP module name (APA) of which the APID corresponds to AP1 on the virtual server VMA (that is, stores it in a physical disk which realizes the virtual disk of the VM, and registers the information within a directory and so on of the OS).

Next, the deployment unit 14 refers to the deployment information of FIG. 4, and grasps that the server ID: SVB and the APID: AP2 correspond. And the deployment unit 14 refers to the server information of FIG. 2 like the operation mentioned above, generates a virtual server which reflected the server specification corresponding to the server ID: SVB on the test device 1, and deploys a module with the AP module name (APB) of which the APID corresponds to AP2 on the virtual server concerned.

The deployment unit 14 repeats the operation concerned, and deploys the AP module on the virtual server on the test device 1 so that the corresponding relationship between the server ID and the APID indicated by the deployment information may be reflected. Further, as described above, in case the AP information includes the source name and the compilation environment definition information as shown in FIG. 5, using the compilation environment definition information, the deployment unit 14 deploys the AP module which is a result of compilation of the source file which the source name indicates on the virtual server.

In FIG. 7, a state is shown in which, depending on such operation of the deployment unit 14, the AP module (APA) whose APID is AP1 is deployed on a virtual server VMA on the test device 1, the AP module (APB) whose APID is AP2 is deployed on a virtual server VMB, and the AP module (APC) whose APID is AP3 is deployed on a virtual server VMC.

Further, in case the virtual server is generated on the test device 1 in advance and the information of the virtual server concerned is stored in the VM information storage unit 24, the deployment unit 14 may search the virtual server to which the specification of the server indicated by the deployment information is reflected from the VM information storage unit 24 and deploy the AP module on the virtual server concerned.

The VM storage area 15 stores a structure file of the VM to which the AP module is deployed, information of a control program for operating the VM and so on, and information of a memory and a disk area and so on assigned to the VM.

The first test execution unit 16 makes the virtual server generated on the test device 1 execute based on data inputted from outside and performs simulation of the application. The first test execution unit 16 includes a function of a control program called a VM monitor and so on. Also, the first test execution unit 16 may output a simulation execution result to a display unit and so on which is not shown.

Next, entire operation of the first exemplary embodiment will be described using FIGS. 8 and 9.

FIG. 8 indicates a state where the AP information, the server information, the deployment information and the VM information are stored in the repository 2. Specifically, for example, the AP information design unit 11 designs the AP information following an operation by such as a program developer and stores it in the AP information storage unit 21 (Step S1). Also, the server information design unit 17 designs the server information following an operation by such as a data center administrator and stores it in the server information storage unit 22 (Step S2). Also, the deployment information design unit 12 designs the deployment information following an operation by such as a service integrator and stores it in the deployment information storage unit 23 (Step S3). Further, the information may be set by the identical subject and at a different step and a phase in the application service system design, and by a development tool for the step and the phase concerned. Also, the deployment information and the AP information may be stored in the deployment information storage unit 23 and the AP information storage unit 21 in advance respectively, and in that case, processing of Steps S1-S3 is unnecessary.

In the VM information storage unit 24, information of the VM generated on the test device 1 is stored. In case the VM is generated on the test device 1 in advance, such as a control unit on the test device 1 which is not shown may store the VM information of the VM concerned in the VM information storage unit 24 via a communication line and so on which is not shown. Also, in case the deployment unit 14 generates the VM on the test device 1, the deployment unit 14 may store the VM information of the VM concerned in the VM information storage unit 24 via a communication line and so on which is not shown.

In this way, the AP information, the server information, the deployment information and the VM information are stored in each storage unit 21-24 of the repository 2 respectively.

FIG. 9 shows an example of operation in which the deployment unit 14 deploys the AP module on the VM with reference to the repository 2.

The deployment unit 14 refers to the identifier stored in the identifier storage unit 13 and refers to the repository 2 (Step S11). Specifically, the deployment unit 14 refers to each storage unit 21-24 of the repository 2 based on each identifier and acquires various kinds of information.

The deployment unit 14 refers to the deployment information storage unit identifier and acquires the deployment information which the deployment information storage unit 24 of the repository 2 stores. And the deployment unit 14 refers to the deployment information and acquires the corresponding relationship between the server ID and the APID (Step S12). For example, according to the deployment information of FIG. 4, it can be known that the server ID: SVA and the APID: AP1 correspond.

Next, the deployment unit 14 refers to the server information storage unit identifier, refers to the server information storage unit 22 of the repository 2 and acquires the server information. And the deployment unit 14 acquires from the server information concerned the server specification corresponding to each server ID which is indicated by the deployment information acquired in Step S12 respectively, and based on the server specification acquired, generates the virtual server on the test device 1 or searches the virtual server on the test device 1 (Step S13). That is, in case the virtual server which reflected the server specification is not generated on the test device 1 in advance, the deployment unit 14 generates the virtual server which reflected the server specification on the test device 1. On the other hand, in case the virtual server is generated on the test device 1 in advance, the deployment unit 14 refers to the VM information storage unit 24 based on the VM information storage unit identifier and searches the virtual server which reflected the server specification.

Next, the deployment unit 14 refers to the AP information storage unit identifier and acquires the AP information stored in the AP information storage unit 21 of the repository 2. And the deployment unit 14 deploys the module with the AP module name corresponding to each APID of the deployment information acquired in Step S 12 on each virtual server generated or searched in Step S13 (Step S14). That is, the deployment unit 14 deploys the module with the AP module name corresponding to each APID which the deployment information indicates on each virtual server to which is reflected the server specification corresponding to the server ID to which each APID of the deployment information corresponds. Further, in case the APID is made to correspond to the source name and the compilation environment definition information as shown in FIG. 5, based on the compilation environment definition information, the deployment unit 14 deploys the AP module which is a result of compilation of the source file which the source name indicates on the virtual server.

Next, the first test execution unit 16 executes each virtual server on the test device 1 to which the AP module is deployed based on data inputted from outside and performs simulation of the application (Step S15). The first test execution unit 16 may output a simulation execution result to a display unit and so on which is not shown.

According to this exemplary embodiment, since simulation environment is built by deploying the AP module on the virtual server of the test device 1 which reflected the server information, it is possible to build the simulation environment of the application appropriately.

### Exemplary Embodiment 2

Next, the second exemplary embodiment of the present invention will be described using drawings. An example of a test system 4 of this exemplary embodiment is indicated in FIG. 10. The test system 4 of this exemplary embodiment further includes a server 3 in addition to the structure described by the first exemplary embodiment. There may be a plurality of units of servers 3.

In the first exemplary embodiment, although the deployment unit 14 of the test device 1 deployed the AP module on the virtual server of the test device 1, this exemplary embodiment is different from the first exemplary embodiment in a point that there is a case when the deployment unit 14 deploys the AP module not only on the virtual server on the test device 1 but also on the server 3.

The server 3 includes a second test execution unit 31. After the AP module is deployed on the server 3 by the deployment unit 14, the second test execution unit 31 makes the server 3 execute the AP module and performs simulation of the application. Also, the second test execution unit 31 may display an execution result of the simulation on a display unit and so on which is now shown. Also, the second test execution unit 31 may transmit the execution result to the test device 1 and output the execution result concerned to a display unit on the test device 1 and so on which is not shown. Also, although the repository 2 and the server 3 are described as different structures in FIG. 10, the repository 2 may be allocated on the server 3.

An example of the AP information stored in the AP information storage unit 21 of this exemplary embodiment will be described using FIG. 11. As shown in FIG. 11, the AP information makes correspond the APID and an attribute and stores them. In case the AP module is calling internally a large-scale distributed storage such as, for example, a Hadoop Hbase or a Hadoop HDFS (Hadoop Distributed File System), a large-scale distributed file system and so on, a load of the test device 1 can become high during simulation. Therefore, there is a case when it becomes difficult to build a simulation environment only on the test device 1 described by the first exemplary embodiment. Therefore, depending on the AP module, there is a case when it becomes desirable to generate a simulation execution environment not only on the test device 1 but also on the server 3 and perform simulation of the application.

Therefore, as shown in FIG. 11, the AP information design unit 11 of this exemplary embodiment makes correspond: the attribute which is 1 in case the AP module is calling the large-scale distributed storage or the file system which an administrator and so on designated in advance and 0 in case it is not so, to the APID; and stores them in the AP information. Since presence or absence of such calling of the storage or the file system by the AP module is expressed in application logic configuration information, a control unit and so on which is not shown may give the attribute of the AP module for each AP module by reading the application logic configuration information from the AP information storage unit 21. Also, the AP information storage unit 21 may store the AP modules separately in advance as a virtual server module which is deployed on the virtual server and a server module which is deployed on the server 3.

When the deployment unit 14 deploys the AP module on the server 3, it performs generation and so on of the virtual server on the server 3 same as the first exemplary embodiment. Also, the deployment unit 14 may deploy the AP module directly on the server 3. In this case, the server 3 includes the execution environment of the AP module concerned.

Next, operation of this exemplary embodiment will be described using FIG. 12.

The deployment unit 14 refers to the identifier storage unit 13 and refers to the repository 2 (Step S21). Specifically, the deployment unit 14 refers to each storage unit 21-24 of the repository 2 based on each identifier and acquires various kinds of information.

The deployment unit 14 refers to the deployment information storage unit identifier, refers to the deployment information storage unit 24 and acquires the deployment information which the deployment information storage unit 24 stores. And the deployment unit 14 refers to deployment information and acquires the corresponding relationship between the server ID and the APID (Step S22).

Next, the deployment unit 14 refers to the AP information storage unit identifier and refers to the AP information stored in the AP information storage unit 21. The deployment unit 14 refers to the AP information and refers to the attribute for each APID acquired in Step S22 (Step S23).

In case the attribute is 0, the deployment unit 14 acquires the server specification for the server ID corresponding to the APID whose attribute is 0 from the server information storage unit 22, and same as the first exemplary embodiment and based on the server specification concerned, generates the virtual server on the test device 1 or searches the virtual server on the test device 1 (Step S24). Next, the deployment unit 14 deploys the module with the AP module name corresponding to the APID on the virtual server concerned (Step S25).

On the other hand, in case the attribute is 1, the deployment unit 14 acquires the server specification for the server ID corresponding to the APID whose attribute is 1 from the server information storage unit 22, and based on the server specification concerned, generates the virtual server on the server 3 or searches the virtual server generated on the server 3 in advance (Step S26). Next, the deployment unit 14 deploys the module with the AP module name corresponding to the APID on the virtual server concerned on the server 3 (Step S27).

For example, according to the AP information shown in FIG. 11, since the attributes of AP1 and AP3 are 0, the deployment unit 14 deploys the module with the AP module name (APA) corresponding to AP1 and the module with the AP module name (APC) corresponding to AP3 on a virtual server VMA on the test device 1 which reflected the server specification corresponding to the server ID: SVA and a virtual server VMC on the test device 1 which reflected the server specification corresponding to the server ID: SVC respectively. Also, since the attribute is 1 for AP2, the deployment unit 14 deploys the module with the AP module name (APB) corresponds to AP2 on a virtual server VMB on the server 3 which reflected the server specification corresponding to the server ID: SVB.

In FIG. 13, a state is shown in which, by the deployment unit 14, the AP module APA is deployed on the virtual server VMA on the test device 1 and the AP module APC is deployed on the virtual server VMC, and the AP module APB is deployed on the virtual server VMB and on the server 3.

Further, although the case when the server 3 is one unit is described here, a plurality of servers 3 may exist. In that case, for example, the AP information storage unit 21 may store the server ID of the deployment destination server to which the AP module is deployed for each AP module. Also, in case the APID is made to correspond to the source name and the compilation environment definition information as shown in FIG. 5, the point that the deployment unit 14, based on the compilation environment definition information, deploys the AP module which is the result of compilation of the source file which the source name indicates on the virtual server or the server 3 according to the attribute of the AP module is same as the first exemplary embodiment.

Next, the first test execution unit 16 makes the virtual server on the test device 1 on which the AP module is deployed execute based on data inputted from outside, and performs simulation of the application (Step S28). The first test execution unit 16 may display the simulation execution result on a display unit and so on which is not shown. Also, the second test execution unit 31 makes the server 3 on which the AP module is deployed execute the AP module, and performs simulation of the application (Step S29). The second test execution unit 31 may transmit the simulation execution result to the test device 1 and output the execution result to the display unit and so on which is not shown. Also, the first test execution unit 16 may gather the execution result of the first test execution unit 16 and the execution result of the second test execution unit 31, and display them on the display unit and so on which is not shown. Thus, according to this exemplary embodiment, it becomes possible to build the environment in which the first test execution unit 16 and the second test execution unit 31 perform simulation cooperatively.

According to this exemplary embodiment, since not only the AP module is deployed on the virtual server of the test device 1 which reflected the server information and the simulation environment is built, but also the AP module is deployed on the server 3 depending on the attribute of the AP module and the simulation environment is built, it becomes possible to build the simulation environment appropriately by considering the load applied to the test device 1 by the simulation. Therefore, according to this exemplary embodiment, even in case distribution is required at a file system layer and so on, by building the execution environment of the simulation also on the server 3, appropriate simulation environment can be built.

Also, even in case the simulation environment extends over the test device 1 which is a client and the server 3, since the simulation is seen for a user to be executed totally on the client, it is possible for the user to perform function verification of the application easily.

### Exemplary Embodiment 3

Next, the third exemplary embodiment of the present invention will be described using drawings. An example of a test device 1 of this exemplary embodiment is indicated in FIG. 14.

The test device 1 of this exemplary embodiment includes an identifier storage unit 13 and a deployment unit 14.

The identifier storage unit 13 stores: an identifier of an AP information storage unit 21 (an AP information storage unit identifier), an identifier of a server information storage unit 22 (a server information storage unit identifier) and an identifier of a deployment information storage unit 23 (a deployment information storage unit identifier).

The deployment unit 14 refers to the deployment information storage unit 23 based on the deployment information storage unit identifier and acquires deployment information. Also, the deployment unit 14 refers to the AP information storage unit 21 based on the AP information storage unit identifier and acquires an AP module corresponding to an APID which the deployment information indicates. Also, the deployment unit 14 refers to the server information storage unit 22 based on the server information storage unit identifier, acquires a server specification corresponding to a server ID which the deployment information indicates and deploys on a virtual server which reflected the server specification concerned the AP module corresponding to the server ID concerned.

According to this exemplary embodiment, since it is possible to deploy the AP module on the virtual server of the test device 1 which reflected the server specification and build a simulation environment, the simulation environment of the application can be built appropriately.

As above, although the present invention has been described with reference to exemplary embodiments, the present invention is not limited to the exemplary embodiments mentioned above. Various changes which a person skilled in the art can understand within the scope of the present invention may be performed in the composition of the present invention and details.

This application claims priority based on Japanese Patent Application No. 2011-168011 filed on Aug. 1, 2011 and the disclosure thereof is incorporated herein in its entirety.

### DESCRIPTION OF CODES

1 Test device

11 AP information design unit

12 Deployment information design unit

13 Identifier storage unit

14 Deployment unit

15 VM storage area

16 First test execution unit

17 Server information design unit

2 Repository

21 AP information storage unit

22 Server information storage unit

23 Deployment information storage unit

24 VM information storage unit

3 Server

31 Second test execution unit

4 Test system

1-19. (canceled)

20. A test device comprising:
an identifier storage unit which stores an identifier of a server information storage unit which stores a server specification for each of a plurality of servers an identifier of an application information storage unit which stores application information including a module name for each of a plurality of applications, and an identifier of a deployment information storage unit which stores deployment information which makes correspond each of said plurality of applications and either of said plurality of servers and
a deployment unit which, by referring to said identifier storage unit, acquires corresponding said server specification and said module name for each of said plurality of applications indicated by said deployment information and deploys a module of the application which the module name concerned indicates on a virtual server on its own device which reflected the server specification concerned.

21. The test device according to claim 20, wherein said application information includes an attribute of the application for each of said plurality of applications; and
said deployment unit determines, depending on said attribute, whether to deploy said module on said virtual server on said own device or to deploy said module on other device different from said own device.

22. The test device according to claim 20, wherein said plurality of applications includes the application which communicates with either of said plurality of servers other than the server to which the module of own application is deployed,
each of said server specification of said plurality of servers includes a connection relationship between the own server and other server which is either of said plurality of servers; and
said deployment unit sets a virtual communication path between said servers based on said connection relationship.

23. The test device according to claim 20, wherein said application information includes a source program name and compilation environment definition information; and
said deployment unit compiles a source code which said source program name indicates and deploys the compilation result concerned.

24. The test device according to claim 20, wherein said deployment unit refers to said server information storage unit, generates said virtual server which reflected the specification of said server on the own device, and deploys said application on the virtual server concerned.

25. The test device according to claim 20, wherein said identifier storage unit further stores an identifier of a VM information storage unit which stores the specification of the virtual server generated on the own device; and
said deployment unit refers to said VM information storage unit, searches said virtual server which reflected the specification of said server, and deploys said application on the virtual server concerned.

26. A test system comprising;
said other device and the test device according to claim 21.

27. A non-transitory computer-readable storage medium storing a test program which makes a computer comprising an identifier storage unit which stores: an identifier of a server information storage unit which stores a server specification for each of a plurality of servers; an identifier of an application information storage unit which stores application information including a module name for each of a plurality of applications; and an identifier of a deployment information storage unit which stores deployment information which makes correspond each of said plurality of applications and either of said plurality of servers; execute
a deployment step which, by referring to said identifier storage unit, acquires corresponding said server specification and said module name for each of said plurality of applications indicated by said deployment information and deploys a module of the application which the module name concerned indicates on a virtual server on said computer which reflected the server specification concerned.

28. The non-transitory computer-readable storage medium according to claim 27 storing said test program, wherein said application information includes an attribute of the application for each of said plurality of applications; and which makes said computer execute
said deployment step which determines, depending on said attribute, whether to deploy said module on said virtual server on said computer or to deploy said module on other device different from said computer.

29. The non-transitory computer-readable storage medium according to claim 27 storing said test program, wherein said plurality of applications include the application which communicates with either of said plurality of servers other than the server to which the module of own application is deployed; and
each of said server specification of said plurality of servers includes a connection relationship between the own server and other server which is either of said plurality of servers; and
which makes said computer execute said deployment step which sets a virtual communication path between said servers based on said connection relationship.

30. The non-transitory computer-readable storage medium according to claim 27 storing said test program, wherein said application information includes a source program name and compilation environment definition information; and
which makes said computer execute said deployment step which compiles a source code which said source program name indicates and deploys the compilation result concerned.

31. The non-transitory computer-readable storage medium according to claim 27 storing said test program which makes said computer execute said deployment step which refers to said server information storage unit, generates said virtual server which reflected the specification of said server on said computer, and deploys said application on the virtual server concerned.

32. The non-transitory storage medium according to claim 27 storing said test program, wherein said identifier storage unit further stores an identifier of a VM information storage unit which stores the specification of the virtual server generated on said computer; and
which makes said computer execute said deployment step which refers to said VM information storage unit, searches said virtual server which reflected the specification of said server, and deploys said application on the virtual server concerned.

33. A test method comprising:
storing an identifier of a server information storage unit which stores a server specification for each of a plurality of servers; an identifier of an application information storage unit which stores application information including a module name for each of a plurality of applications; and an identifier of a deployment information storage unit which stores deployment information which makes correspond each of said plurality of applications and either of said plurality of servers; in an identifier storage unit; and
by referring to said identifier storage unit, acquiring corresponding said server specification and said module name for each of said plurality of applications indicated by said deployment information and deploys a module of the application which the module name concerned indicates on a virtual server on its own device which reflected the server specification concerned.

34. The test method according to claim 33, wherein said application information includes an attribute of the application for each of said plurality of applications; and the test method comprises:
determining, depending on said attribute, whether to deploy said module on said virtual server on said own device or to deploy said module on other device different from said own device.

35. The test method according to claim 33, wherein said plurality of applications includes an application which communicates with either of said plurality of servers other than the server to which the module of own application is deployed; and
each server specification of said plurality of servers includes a connection relationship between the own server and other server which is either of said plurality of servers; and the test method comprises:
setting a virtual communication path between said servers based on said connection relationship.

36. The test method according to claim 33, wherein said application information includes a source program name and compilation environment definition information; and the test method comprises: compiling a source code which said source program name indicates and deploying the compilation result concerned.

37. The test method according to claim 33 comprising referring to said server information storage unit, generating said virtual server which reflected the specification of said server on the own device, and deploying said application on the virtual server concerned.

38. The test method according to claim 33, wherein said identifier storage unit further stores an identifier of a VM information storage unit which stores the specification of the virtual server generated on the own device; and the test method comprises:
referring to said VM information storage unit, searching said virtual server which reflected the specification of said server, and deploying said application on the virtual server concerned.

39. A test device comprising:
an identifier storage means for storing: an identifier of a server information storage means for storing a server specification for each of a plurality of servers; an identifier of an application information storage means for storing application information including a module name for each of a plurality of applications; and an identifier of a deployment information storage means for storing deployment information which makes correspond each of said plurality of applications and either of said plurality of servers; and
a deployment means which, by referring to said identifier storage means, acquires corresponding said server specification and said module name for each of said plurality of applications indicated by said deployment information and deploys a module of the application which the module name concerned indicates on a virtual server on its own device which reflected the server specification concerned.
